(19) United States
(12) Patent Application Publication
(10) Pub. No.: US 2026/0166933 A1
(43) Pub. Date: Jun. 18, 2026

(54) SYSTEM AND METHOD FOR DISCONNECTING AN AIR SUPPLY LINE FROM A TRAILER

(71) Applicant: Torc Robotics, Inc., Blacksburg, VA (US)

(72) Inventors: William Gray Davis, Austin, TX (US); Joseph R. Fox-Rabinovitz, Austin, TX (US)

(21) Appl. No.: 18/986,322

(22) Filed: Dec. 18, 2024

(51) Int. Cl. B60D 1/28; B60D 1/64

(52) U.S. Cl. CPC B60D 1/28; B60D 1/64

(57) ABSTRACT

An appendage disconnection system for an autonomous vehicle includes a coupler coupled to a hose, the coupler including a first coupling half removably attached to a trailer and a second coupling half attached to a tractor portion of the autonomous vehicle, the coupler moveable between a first orientation and a second orientation. The coupler further includes an actuation mechanism adapted to impede and enable movement of the first coupling half relative to the second coupling half.

### TECHNICAL FIELD

The present disclosure relates generally to the field of transportation logistics for autonomous vehicles, such as tractor-trailers. More specifically, the present disclosure relates to systems and methods for automatically disconnecting appendages between a trailer portion and a tractor portion, for example an electric plug(s) and an air hose(s).

### BACKGROUND

Some autonomous vehicles include multiple bodies, such as autonomous trucks with a tractor portion and a trailer portion. The trailer portion may be coupled or linked to the tractor portion. Certain appendages are connected between the tractor portion and a wall of the trailer portion. The appendages may comprise one or more electric cables and/or one or more air hoses that extend between the tractor and the trailer. Air hoses for tractor-trailers, are typically connected to trailer portion of a tractor-trailer combination using glad hand connectors. The glad hand connectors have two interlocking members that are fitted to the hoses. After the hose(s) are connected to the trailer, pressurized air is supplied from the tractor, through the hoses, to the trailer. The glad hand connectors are coupled together to join the hoses together. Conventional glad hands used throughout the tractor-trailer industry do not include a mechanism that automates the unlocking of the glad hands and releasing of the hoses. Uncoupling conventional glad hands is a manual process, requiring an operator to rotate the glad hands in order to uncouple the glad hands and thereby release the air hose appendage.

When the autonomous truck is operational (e.g., driving or moving along a roadway), the autonomous truck may experience an emergency, such as a fire located in the trailer portion, or tractor portion. During such an emergency, it is critical that the appendages such as air hoses and electric cables be quickly disconnected from the trailer so that the tractor portion can be effectively separated from the trailer portion. Because the current systems and methods for disconnecting the air hoses, electric cables, and other appendages from the trailer portion are highly manual, when an emergency occurs, a tractor-trailer operator must be present and the tractor-trailer operator must leave the cab to disconnect the hoses and cables. In an emergency, it may be unsafe for the operator to leave the tractor portion to make the necessary disconnections. Also, there may not be sufficient time to leave the cab to safely make the manual disconnections. As a result, frequently the appendages are ripped out of the trailer portion when the trailer portion and tractor portion are separated during the emergency. When the appendages are ripped out from the trailer portion, brakes on the trailer portion and tractor portion lock, thereby preventing the tractor portion from traveling a safe distance from the trailer portion. Accordingly, a system to automate the disconnection of the appendages from a trailer, including sensors - to monitor for emergency situations - is required.

Additionally, there is a need for a system for disconnecting appendages, such as air hoses associated with non-emergency events or situations. A system for providing automated air hose disconnection can improve the operation of trailer use even in non-emergency situations. For example, when delivering a trailer to a hub, an improved system for automating disconnection of appendages between the tractor and trailer will enable the trailer portion to be disconnected from the vehicle/tractor portion without the need for operator intervention; thereby yielding time-and cost savings. Since some trailers may be universal to both autonomous and manual tractors, the system can be a self-contained unit, i.e. integrated in the appendages, that does not require customization to work with a given trailer portion.

Accordingly, there exists a need for a system and a method for automating detachment of appendages extending between a tractor portion and a trailer portion that address the foregoing and other issues. These and other needs are met by the exemplary system for automatically detaching appendages, such as air hoses(s) discussed herein.

This section is intended to introduce the reader to various aspects of the art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### BRIEF DESCRIPTION

According to one aspect of the disclosure, a system for disconnecting an appendage, for example an air hose, from an autonomous vehicle, wherein the autonomous vehicle is selectively coupled to a trailer. The system includes a coupler located along a hose, the coupler being selectively connected to the trailer and an actuation mechanism configured to impede movement of the coupler to maintain the coupler in a first orientation and to enable movement of the head to a second orientation.

In some aspects, the system may include a coupler that comprises a pair of coupling halves, a second coupling half being movable relative to a first coupling half between the first orientation where a face of the first coupling half and a face of the second coupling half are held in sealing engagement and the second orientation where the first coupling half and the second coupling half are separated.

In some aspects, the system may include the face of the first coupling half and the face of the second coupling half each have an opening formed therethrough.

In some aspects, the system may include the opening of the first coupling half being in fluid communication with the hose.

In some aspects, the system may comprise an actuation mechanism having a body coupled to a top portion of the first coupling half and further comprising at least one mating connector configured to translate along the body via a pair of rails. The pair of rails enable movement of the at least one mating connector along the body.

In some aspects, the system may include an actuation mechanism that further comprises a first mating connector and a second mating connector.

In some aspects, the actuation mechanism of the system may be configured to maintain relative positions of the first coupling half and the second coupling half substantially constant, and wherein the actuation mechanism is configured to enable a relative, opposed rotational motion between the first coupling half and the second coupling half.

In some aspects, the system may comprise a clasp rotatably coupled to a bottom portion of the first coupling half, defining a channel therebetween.

In some aspects, the second coupling may further comprise a bottom portion, the bottom portion of the second coupling half may be located in the channel in the first orientation.

In some aspects, the clasp may be adapted to rotate away from the first coupling half and enable the second coupling half to disconnect from the first coupling half.

According to another aspect of the disclosure, the system for disconnecting an appendage, includes a connecting member located along a supply line and an actuation mechanism configured to impede movement of the connecting member to maintain the connecting member in a first orientation and to enable movement of the connecting member to a second orientation.

In some aspects, in the system of the present disclosure, the connecting member is a coupler and the supply line is a hose.

In some aspects, the system connecting member may further comprise a pair of coupling halves, a second coupling half being movable relative to a first coupling half between the first orientation where a face of the first coupling half and a face of the second coupling half are held in sealing engagement and the second orientation where the first coupling half and the second coupling half are separated, and the face of the first coupling half and the face of the second coupling half each have an opening formed therethrough. The system may further include a clasp rotatably coupled to a bottom portion of the first coupling half.

In some aspects, the system may include the opening of the first coupling half and/or the opening of the second coupling half are in fluid communication with the supply line.

In some aspects, the actuation mechanism may comprise a body coupled to a top portion of the first coupling half and further comprising at least one mating connector configured to translate along the body, via a pair of rails. The pair of rails enable movement of the at least one mating connector along the body.

In some aspects, the actuation mechanism may be configured to maintain relative positions of the first coupling half and the second coupling half substantially constant, and wherein the actuation mechanism is configured to enable a relative, opposed motion between the sleeve and first coupling half and the second coupling half.

In some aspects, the actuation mechanism may be electrically triggered or mechanically triggered.

According to another aspect of the disclosure, a method for disconnecting an appendage, from an autonomous vehicle is disclosed. The autonomous vehicle is selectively coupled to a trailer. The disclosed method relates to a method of disconnecting a connecting system from an autonomous vehicle, wherein the autonomous vehicle is selectively coupled to a trailer. The connecting system comprises a coupler having a first coupling half and a second coupling half, the first coupling half and the second coupling half being movable relative to each other, an actuation mechanism having a body and at least one mating connector moveably coupled to the body, the actuation mechanism coupled to a top portion of the first coupling half and configured to impede relative movement between the first and the second coupling halves in a first orientation where the first coupling half is connected to the trailer, and to enable relative movement of the first and the second coupling halves in opposite rotational directions to assume a second orientation where the first coupling half is disconnected from the trailer, and a clasp rotatably coupled to a bottom portion of the first coupling half, defining a channel therebetween. The method comprises holding a bottom portion of the second coupling half in the channel, wherein a sealing contact between the first coupling half and the second coupling half is maintained, allowing air can flow through aligned central openings of the first and the second coupling halves. The method further comprising impeding the relative movement between the first and the second coupling halves by the actuation mechanism to maintain a first relative orientation. The method further comprising enabling the relative movement between the first and the second coupling halves by the actuation mechanism. The method further comprising rotating the first and the second coupling halves in opposite relative rotational directions to a second relative orientation and thereby disconnect the first coupling from the trailer.

In some aspects, the method may include sending a signal to the actuation mechanism, the signal including disconnection instructions, activating the actuation mechanism, and rotating the second coupling half a predetermined distance relative to the first coupling half from the first orientation to the second orientation.

In some aspects, the method may include rotating the clasp away from a face of the first coupling half and releasing the first coupling half from the second coupling half.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a perspective view of a vehicle of the present disclosure;

FIG. 2 is a perspective view of the vehicle of FIG. 1 with a trailer attached thereto;

FIG. 3A is a side view of the vehicle with attached trailer of FIG. 2;

FIG. 3B is an enlarged view of the portion of the vehicle of FIG. 3A, enclosed in the area identified as 3B in FIG. 3A;

FIG. 3C is a schematic of the appendage disconnection system and a computing system;

FIG. 4 is a block diagram of the autonomous truck shown in FIG. 1;

FIG. 5 is a block diagram of an example computing system;

FIG. 6A is a front and side view of a disconnection device in a connected position;

FIGS. 6B and 6C are front and side views of a portion of the disconnection device of FIG. 6A;

FIG. 6D is a front view of the disconnection device of FIG. 6A in a disconnected position; and

FIG. 7 is a flowchart depicting an example method of disconnecting the appendage disconnection system in accordance with an embodiment.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

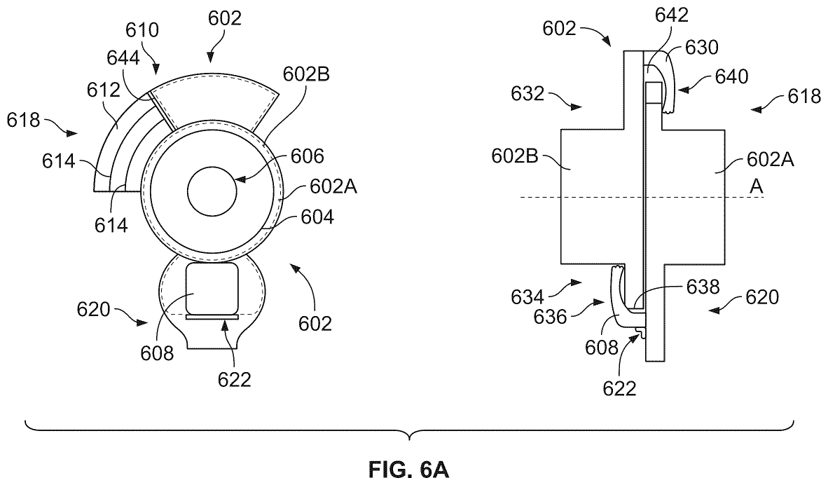

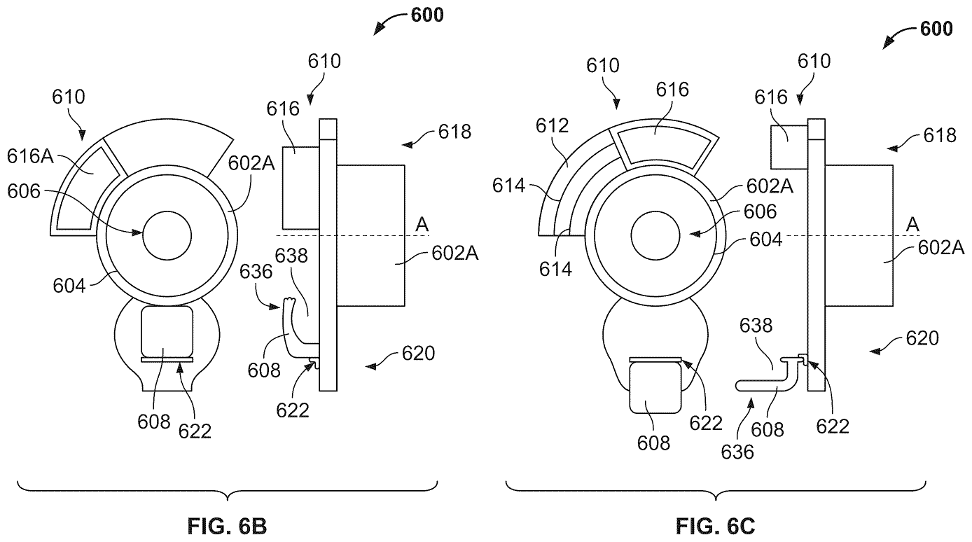

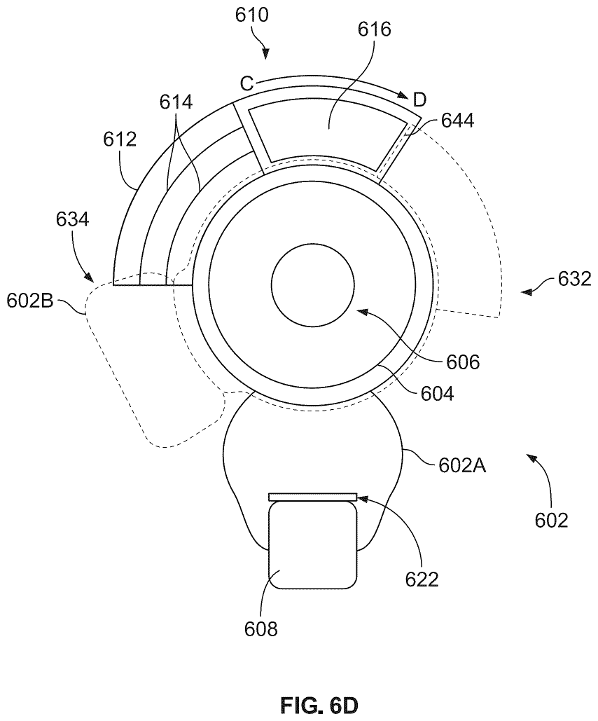

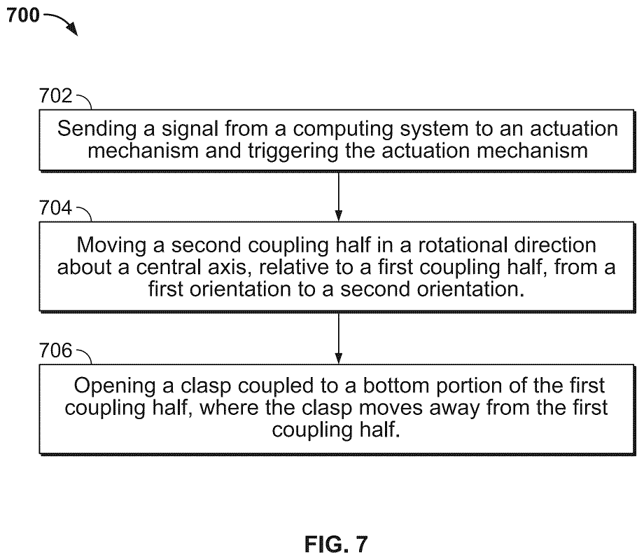

The present disclosure relates to systems and methods for connecting and disconnecting appendages, such as air hoses, connected between a tractor, i.e. vehicle, and trailer, as described in detail below in connection with FIGS. 6A-6D and 7.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As described herein, an appendage disconnection system for disconnecting an appendage, such as an air hose, of a vehicle from a trailer after a trigger event. The trigger event may include, but not limited to, when a sensor of the vehicle and/or trailer, described below, detects an emergency situation, when a certain event occurs - for example when the vehicle arrives at its destination, or when the system is triggered by an operator. The appendage disconnection system includes a disconnection device and is in electrical communication with the sensors of the vehicle and/or sensors of the trailer. The sensors monitor the status of the vehicle and trailer. The disconnection device is further in electrical communication with a computing system, described below. The computing system sends disconnection instructions to the disconnection device when a trigger event is detected, for example an emergency situation, arrival at a predetermined location, or an operator sending disconnection instructions to the control system of the vehicle.

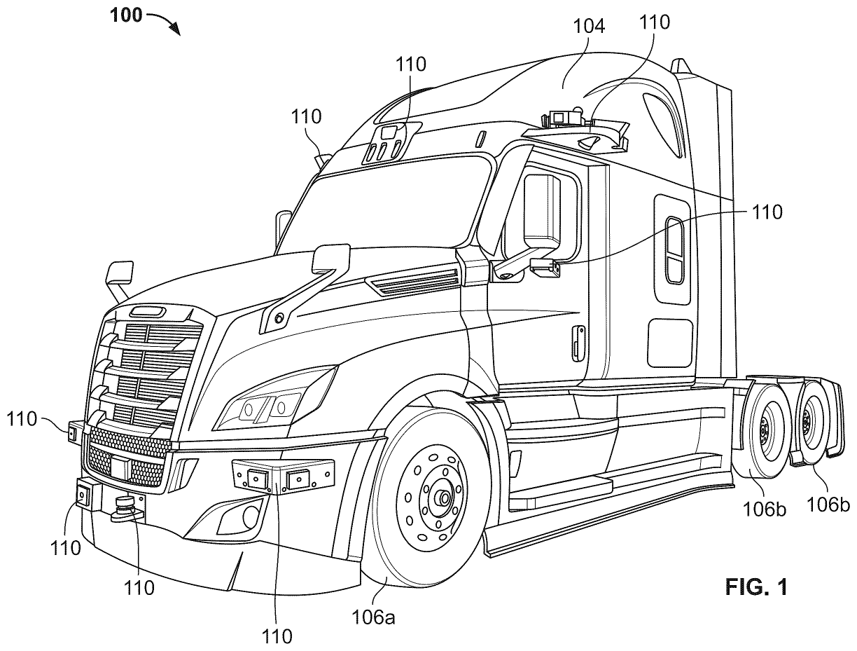

Various embodiments of the sensors of the vehicle and trailer in the present disclosure are described with reference to FIGS. 1-5 below.

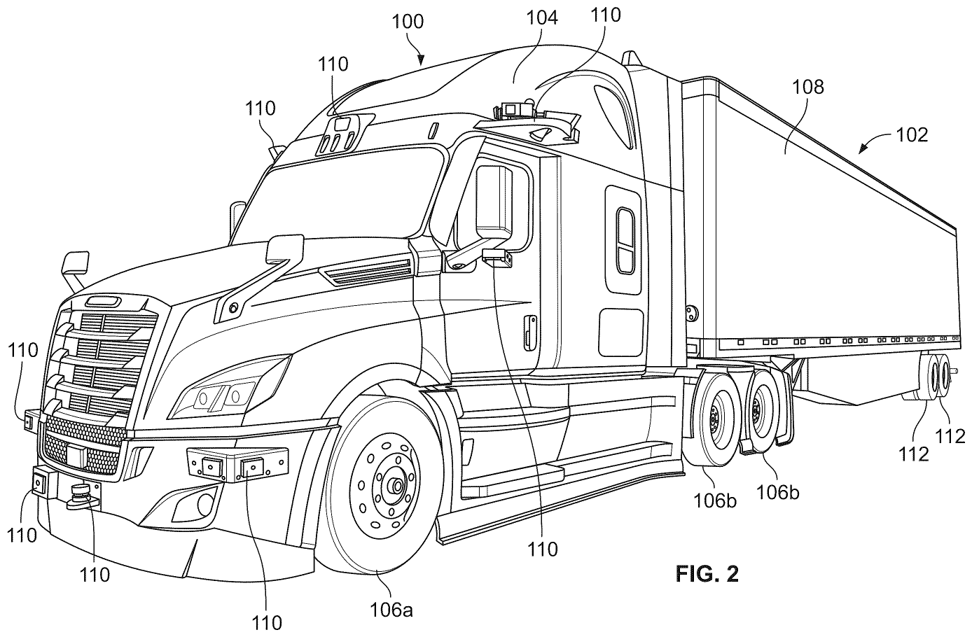

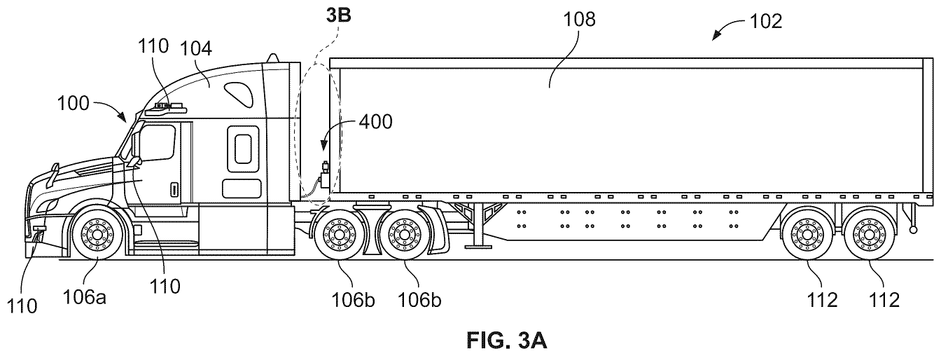

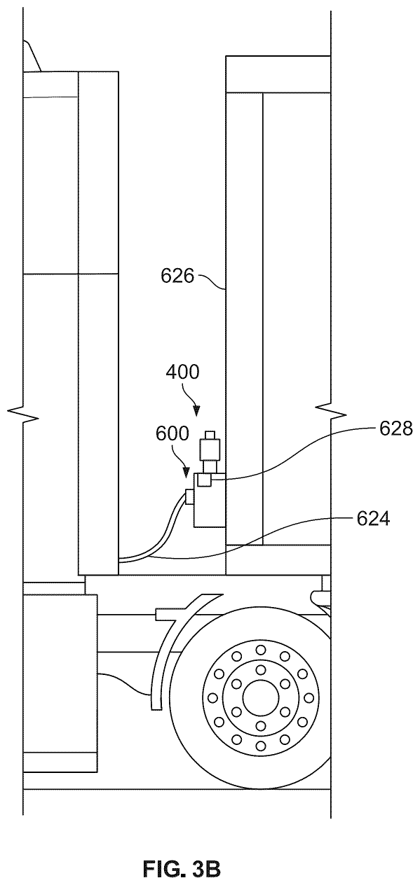

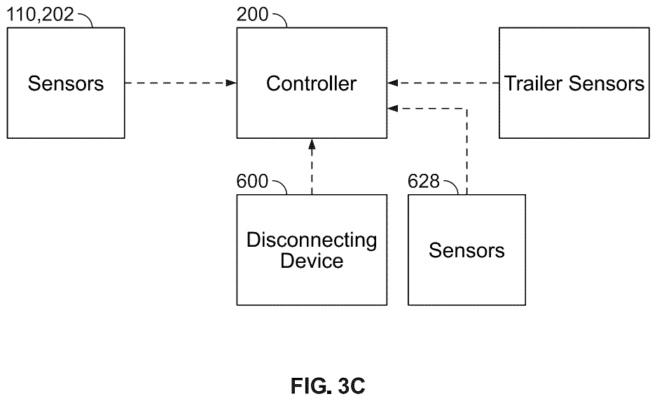

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

Similar sensors can be used around the perimeter of the vehicle 100 to ensure full environmental coverage around the vehicle 100 is provided by the sensors. In some embodiments, the vehicle 100 can include, e.g., 5-6 LIDAR sensors, 8-10 cameras, combinations thereof, or the like. In some embodiments, the vehicle 100 can tow a trailer and the trailer can similarly include LIDAR sensors and/or cameras to provide field-of-view coverage around the perimeter of the vehicle 100 and the trailer 102 and monitor the status of the trailer 102. The environmental coverage by the sensors and/or cameras therefore provides data corresponding with the front, rear, sides and corners of the vehicle 100 and the trailer 102 hauled by the vehicle 100.

FIG. 3A is a side view of the vehicle with attached trailer. The vehicle includes an appendage disconnection system 400. The appendage disconnection system 400 extends between the vehicle 100 and a wall 626 of the trailer 102, as shown in FIG. 3B. FIG. 3C is a schematic of the appendage disconnection system and a computing system. The appendage disconnection system 400 may include a disconnecting device 600 and sensor(s) 628, as described below. The sensor(s) 628 and sensors 110 and 202, and optional trailer sensors (not shown) are in electronic communication with a computing system, for example an autonomy computing system 200 described below. The sensor(s) 628 monitor the status of the disconnecting device 600 and sensors 110 and 202 monitor the status and surroundings of the vehicle and trailer and send information to the computing system. The optional trailer sensors monitor the status and surroundings of the trailer and send information to the computing system. Upon detection of a predefined trigger event by the computing system based on the information provided by the sensors 110, 202, and/or 628, instructions are sent from the computing system to the disconnecting device to disconnect.

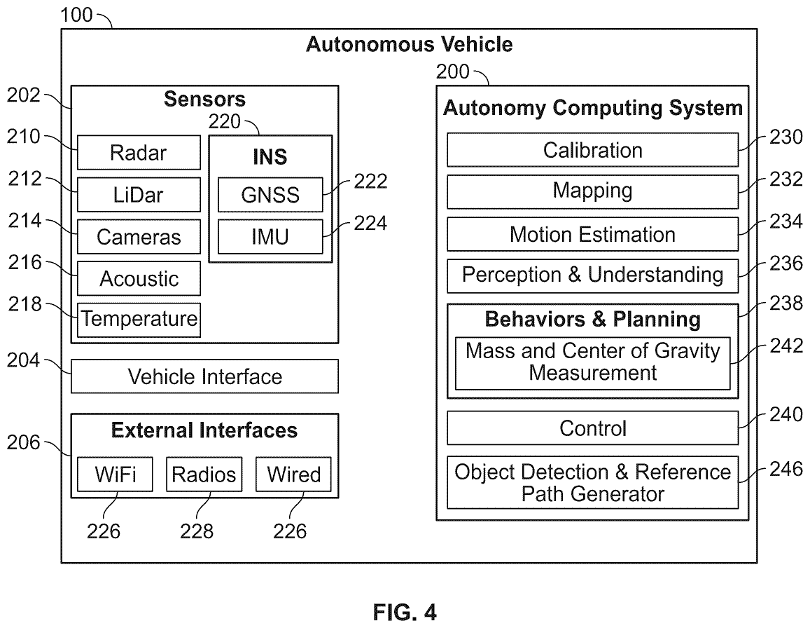

FIG. 4 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100, of the trailer 102, and its proximity. As described in further detail below, these signals may be used by autonomy computing system 200 to determine how to control operations of autonomous vehicle 100, including disconnecting the appendage system.

Cameras 214 are configured to capture images of the environment surrounding the autonomous vehicle 100 in any aspect or field of view (FOV). The FOV can have any angle or aspect such that images of the areas ahead of, to the side, behind, above, or below the autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize the autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, the autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electro-mechanical-systems (MEMS) device that measures and reports one or more features regarding the motion of the autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of the autonomous vehicle 100. In some embodiments, the trailer associated with the vehicle 100 can include similar sensors 202 for gathering similar data associated with the trailer, thereby further assisting with control operations of the autonomous vehicle 100 and the appendage disconnection system 400.

In the example embodiment, autonomy computing system 200 employs vehicle interface 204 to send commands to the various aspects of autonomous vehicle 100 that actually control the motion of the autonomous vehicle 100 (e.g., engine, throttle, steering wheel, brakes, etc.) and to receive input data from one or more sensors 202 (e.g., internal sensors). The autonomy computing system 200 may further receive input data from the sensor(s) 628. External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

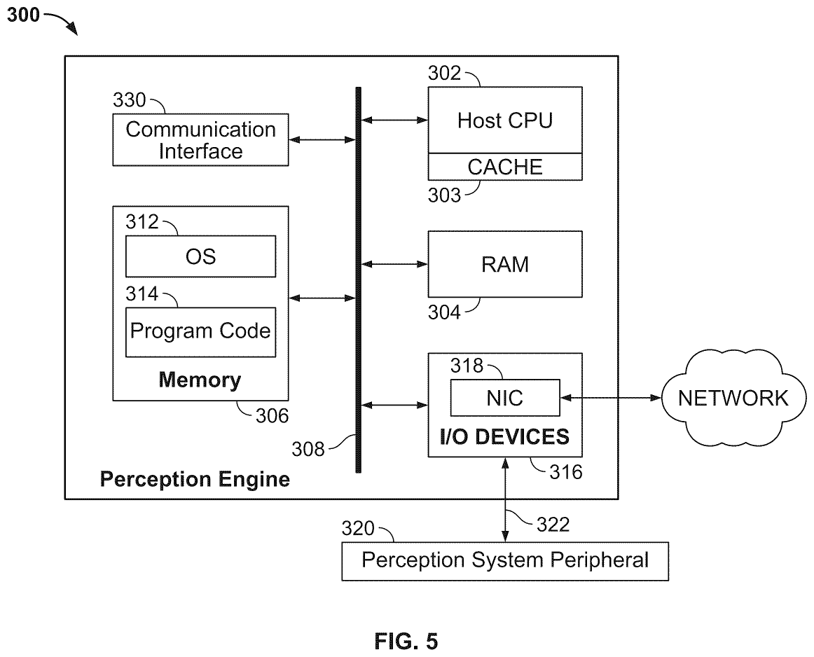

FIG. 5 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

Referring to FIGS. 6A-6D embodiments are shown of an appendage disconnection system 400. The system 400 is also identified schematically in FIG. 3B. In this embodiment, the appendage disconnection system 400 is an air hose disconnection system. The appendage disconnection system 400 includes a disconnecting device 600 adapted to be in communication with a computing system, for example the autonomy computing system 200. The appendage disconnection system 400 may further include at least one sensor 628 (FIG. 3B). The sensor(s) 628 is in electrical communication with the autonomy computing system 200. The sensor(s) 628 generate respective output signals based on detected physical conditions of the disconnection device 600. In some embodiments, the data generated by sensor(s) 628 may be transmitted to mission control. The disconnecting device 600 includes a gladhand coupler 602, a clasp 608, and an actuation mechanism 610. The coupler 602 connects to a hose 624 (FIG. 3B) that is attached to a wall 626 (FIG. 3B) of the trailer 102 and connects to another hose or hose shank shaft (not shown) that is attached to the vehicle 100. The hose 624 connected to the vehicle 100 provides air to the trailer 102 from the vehicle 100 via the coupler 602.

Referring to FIG. 6A, the gladhand coupler 602 comprises a pair of like coupling halves 602A, 602B. In the front view, coupling half 602B is shown in dashed lines so that the coupling half 602A can be clearly shown. The coupling halves 602A, 602B are interlocking members and have substantially similar structures. The gladhand coupler is hermaphroditic, allowing each coupling half to attach to any other coupling half. The coupling halves 602A, 602B may be rotatably coupled together. One coupling half or each coupling half may be attached to an air hose shank (not shown) for operably coupling the one or more coupling halves to an air hose, for example hose 624. The sensor 628 monitors the coupling halves'602A, 602B connection with each other. If the sensor detects an improper connection such that the coupling halves 602A, 602B may become disconnected, a warning signal is sent to the autonomy computing system 200.

The first coupling half 602A is hollow and includes face 604 having an opening 606 formed therethrough to define an air passage that is in fluid communication with the air hose 624 attached thereto. The coupling halves 602A, 602B are connected to and disconnected from each other by rotating the second coupling half 602B relative to the first coupling half 602A, thereby connecting or disconnecting the air hose(s). Relative rotation of the second coupling half 602B in a first direction connects the coupling halves and relative rotation of the second coupling half 602B in a second direction disconnects the coupling halves. In some embodiments, the first direction is counterclockwise and the second direction is clockwise. The relative motion is represented in FIGS. 6A and 6D. The actuation mechanism 610 is configured to enable the relative displacement between the coupling halves 602A and 602B. More specifically, the relative displacement is comprised of rotating the second coupling half 602B about a central axis A between a first orientation, that enables the connection of the coupling halves 602A, 602B, and a second orientation that enable the coupling halves 602A, 602B to be disconnected. In the first orientation the coupling halves 602A, 602B are in a connected position, as shown in FIG. 6A. The first coupling half 602A and the second coupling half 602B are in a first relative orientation where the coupling halves are in alignment, in the connected position. In the second orientation the coupling halves 602A, 602B are in a disconnect position, as shown in FIG. 6D. The first coupling half 602A and the second coupling half 602B are in a second relative orientation, where the first coupling half 602A and the second coupling half 602B are not in alignment, in the disconnected position.

The clasp 608 is coupled to the first coupling half 602A and positioned approximately on a lower or bottom portion 620 of the first coupling half 602A. The clasp 608 may have an L-shape, substantially L-shape, U-shape, substantially U-shape, squared C-shape, or substantially squared C-shape. The clasp 608 may be coupled to the first coupling half 602A via a hinge 622 to enable the clasp 608 to be moved toward and away from the first coupling half 602A. A distal end 636 of the clasp 608 in combination with the bottom portion 620 of the first coupling half 602A defines a channel 638. The clasp 608 may have a width dimension that is of substantially the same magnitude as the width dimension of the bottom portion 620 of the first coupling half 602A. In some embodiments, the clasp 608 may have a width dimensioned between 50-100%, inclusive, of the width dimension of the bottom portion 620. When the coupling halves 602A and 602B are brought into mating contact, a bottom portion 634 of the second coupling half 602B is located in the defined channel 638 (See FIG. 6A).

The second coupling half 602B includes a substantially similar clasp 630, coupled to a top or upper portion 632 of the second coupling half 602B. The clasp 630 includes a distal end 640 forming a channel 642 between the distal end 640 and the upper portion 632 of the second coupling half 602B. The second coupling half 602B includes a face (not shown) having an opening as described above with respect to the first coupling half 602A. The clasp 630 of the second coupling half 602B is fixed and not moveable relative to the second half 602B. Similar to clasp 608, clasp 630 may have a width dimension that is of substantially the same magnitude as the width dimension of an upper portion 632 of the second coupling half 602B. In some embodiments, the clasp 630 may have a width dimensioned between 50-100%, inclusive, of the width dimension of the upper portion 632.

As shown in FIG. 6A, the top portion 618 of the first coupling half 602A is located in the channel 642 and the bottom portion 634 of the second coupling half 602B is located in the channel 638 when the first coupling half 602A and the second coupling half 602B are in the first orientation. The face 604, (not shown), of the coupling halves 602A, 602B are held in sealing engagement as a result of a force fit when the coupling halves 602A, 602B are positioned in the associated channel 638, 642.

Referring to FIGS. 6B and 6C, the actuation mechanism 610 is coupled to the top portion 618 of the first coupling half 602A. The second coupling half 602B is not shown in FIGS. 6B and 6C so that the actuation mechanism 610 can be clearly shown. In some embodiments, the actuation mechanism 610 has an arcuate-trapezoidal shape, a substantially arcuate-trapezoidal shape, arcuate-parallelogram shape, or substantially arcuate-parallelogram shape. The actuation mechanism 610 may span 40-80 degrees of the face 604, inclusive, as shown in FIGS. 6B-6D. In some embodiments, the body 612 may comprise a rail that may span 30-90 degrees of the face 604, inclusive. In some embodiments, the body 612 may span 80-110 degrees of the face 604, inclusive.

As shown in FIG. 6C, an embodiment of the actuation mechanism 610 includes a raised arcuate body 612 with a pair of recessed rails 614 formed on the body 612, and at least one mating connector 616 that is movable along the body 612. The rails 614 extend along the length of the body 612 and are parallel with each other, and enable movement of the at least one mating connector 616 along the length of the body 612. The at least one mating connector 616 rotates about the top portion 618 of the first coupling half 602A along the rails 614. The mating connector 616 may be actuated by a mechanism. The mechanism may be, but not limited to, a biasing member, a motor, or a pneumatic. Where the mechanism is a biasing member, such as a spring, the biasing member may be in a compressed position until activation of the actuation mechanism 610. Upon activation, the biasing member may be released, allowing the biasing member to expand and cause the mating connector 616 to move along the rails 614. Where the mechanism is a motor, the motor may be operably coupled to the mating connector 616 to drive the mating connector 616 along the rails 614. The motor may be mechanically or electrically triggered. Where the mechanism is a pneumatic, the pneumatic may be powered by the hose 624. The pneumatic may be configured to receive pressurized air from the hose 624 and move the mating connect 616 by the pressurized air.

The body 612 may have an arcuate-trapezoidal shape, substantially arcuate-trapezoidal shape, arcuate-parallelogram shape, or substantially arcuate-parallelogram shape. The body 612 may span 40-80 degrees of the face 604, inclusive, as shown in FIG. 6C. In some embodiments, the body 612 may span 30-90 degrees of the face 604, inclusive. In some embodiments, the body 612 may span 80-110 degrees of the face 604, inclusive. The at least one mating connector 616 may have substantially the same shape as the body 612 and may have a length dimensioned shorter than the length of the body 612.

When the coupling halves 602A, 602B are coupled together, the coupler 602 is in the connected position, as shown in FIG. 6A. Upon activation of the actuation mechanism 610, the actuation mechanism 610 causes the second coupling half 602B to rotate a predetermined distance to the second orientation, as shown in FIG. 6D. The actuation mechanism may comprise the actuation mechanisms shown in FIGS. 6A-6D . Upon the second coupling half 602B completing its rotation about a central axis A, the clasp 608 is triggered to rotate away from the face 604 of the first coupling half 602A and release the coupling halves. In the second orientation, the clasp 608 rotates or is otherwise moved away from the face 604 via the hinge 622 (the side view of FIG. 6C) to release the sealing contact between the coupling halves 602A, 602B and allow the coupling halves to separate.

Referring to FIG. 3C, the sensors 110, 202, and 628, and the optional trailer sensors, collect information, as described above, and transmit the information to a controller, for example the autonomy computing system 200. When the sensors 110, 202 of the vehicle 100 and/or the sensors of the trailer 102 detect a trigger event, for example an emergency situation, instructions are sent to the disconnection device 600, for example from the autonomy computing system 200, to rotate the second coupling half 602B to the second orientation. The actuation mechanism 610 is configured to receive one or more signals from the autonomy computing system 200, the signal(s) including the disconnection instructions. Upon detection of a trigger event, for example an accident, the autonomy computing system 200 issues a disconnection signal to the actuation mechanism 610, which, upon receiving the disconnection signal, the actuation mechanism 610 causes the second coupling half 602B to rotate to the second orientation. In particular, upon receiving the disconnection signal, the actuation mechanism 610 is activated, driving the mating connector 616 to move along the rails 614. The mating connector 616 contacts a contact edge 644 of the upper portion 632 of the second coupling half 602B. Movement of the mating connector 616 causes reciprocating movement of the second coupling half 602B, thereby rotating the second coupling half 602B about the central axis A to the second orientation (see FIG. 6D). The contact edge 644 rotates from point C to point D. Upon rotation of the second coupling half 602B, the clasp 608 moves away from the face 604 via the hinge 622, and allowing the second coupling half 602B to fall away from the first coupling half 602A.

As shown in FIG. 6D, in the disconnected position, the upper portion 632 of the second coupling half 602B is rotated a predetermined distance about the central axis A in a clockwise direction away from the top portion 618 of the first coupling half 602A such that the top portion 618 is no longer in the channel 642, and the bottom portion 634 of the second coupling half 602B is no longer in the channel 638. As stated above, the contact edge 644 is rotated from point C to point D when the second coupling half 602B is rotated from the first orientation to the second orientation, as shown in FIG. 6D.

The mating connector 616 and the second coupling half 602B may rotate in a clockwise direction. The mating connector 616 may rotate approximately 90-degrees when rotating the second coupling half 602B to the second relative orientation position. Further, the second coupling half 602B may rotate approximately 90-degrees when rotating from the first orientation to the second orientation. In some embodiments, the mating connector 616 and the second coupling half 602B may rotate approximately 45-90 degrees, inclusive, or may rotate 90-120 degrees, inclusive. In autonomous-trucks, pull-over procedures may be initiated prior to the actuation mechanism 610 being activated and thereby causing the second coupling half 602B to be rotated to the second orientation.

In some embodiments, the mating connector 616 and the second coupling half 602B may rotate in a counterclockwise direction. The mating connector 616 and the second coupling half 602B may rotate the same rotation degrees as described above, however in the opposite direction.

In an alternative embodiment, the mating connector 616 may be comprised of two separate connectors, for example a first mating connector and a second mating connector. In operation, the first mating connector may be moved into contact with the second mating connector. The first mating connector causes reciprocating movement of the second mating connector. The second mating connector contacts the contact edge 644 of the second coupling half, thereby rotating the second coupling half 602B to the second orientation.

Another embodiment of the disconnecting device 600 will be described in detail. Due to similarities between embodiments described herein, like reference numerals may be used to refer to the same or similar features, and detailed descriptions thereof may be omitted for the sake of brevity.

The relative displacement of the coupling halves 602A, 602B is comprised of rotating the first coupling half 602A about the central axis A between a first orientation and a second orientation. The coupling halves 602A, 602B are connected to and disconnected from each other by rotating the first coupling half 602A relative to the second coupling half 602B, thereby connecting or disconnecting the air hose(s). Relative rotation of first coupling half 602A in a first direction connects the coupling halves and relative rotation of the first coupling half 602A in a second direction disconnects the coupling halves. In some embodiments, the first direction is clockwise and the second direction is counterclockwise. In the first orientation the coupling halves 602A, 602B are in a first relative orientation where the coupling halves are in alignment, in the connected position. In the second orientation the coupling halves 602A, 602B are in a second relative orientation, where the first coupling half 602A and the second coupling half 602B are not in alignment, in the disconnected position. Upon activation of the actuator mechanism 610, the mating connector 616 rotates about the body 612, along the rails 614. The mating connector 616 rotates clockwise a predetermined distance and contacts the contact edge 644 of the second coupling half 602B. The actuation mechanism 610 continues to drive the mating connectors 616. Driving the mating connector 616 against the contact edge 644 of the second coupling half 602B causes reciprocating movement of the first coupling half 602A, thereby rotating the first coupling half 602A counterclockwise from the first orientation to the second orientation.

Upon rotation of the first coupling half 602A, the clasp 608 opens via the hinge 622, rotating away from the face 604 and allowing the second coupling half 602B to fall way from the first coupling half 602A. The mating connector 616 and the first coupling half 602A may rotate in a degree of rotation as described above.

As stated above, the first coupling half 602A and the second coupling half 602B may be placed in the second orientation in non-emergency situation, such as when the vehicle arrives at a specified destination. When the vehicle arrives at a specified location, as determined by the GNSS receiver 222, the autonomy computing system 200 may issue a disconnection signal to the actuation mechanism 610. The autonomy computing system 200 may issue the disconnection signal following the completion of pull-over and/or parking procedures. Additionally, the first coupling half 602A and the second coupling half 602B may be placed in the second orientation in non-emergency situation, such as by an operator sending a wireless signal including instructions to disconnect. For example, the wireless signal containing instructions may be sent to the autonomy computing system 200. Upon receipt of the wireless signal from the operator, the autonomy computing system 200 issues a disconnection signal to the actuation mechanism 610. The wireless signal may be sent from inside the vehicle 100 or may be located at a control hub.

FIG. 7 is a flowchart depicting an example method 700 of disconnecting the appendage disconnection system in accordance with some embodiments.

In 702, the method 700 may include sending a signal from the exemplary autonomy computing system to the exemplary actuation mechanism and triggering the actuation mechanism discussed herein (e.g. the autonomy computing system 200 and the actuation mechanism 610). The actuation mechanism is configured to impede relative movement between the exemplary first coupling half and second coupling half discussed herein (e.g. the first coupling half 602A and the second coupling half 602B) to maintain the first coupling half and second coupling half in a first orientation where the first coupling half and the second coupling half are in alignment, and are connected. The actuation mechanism is further configured to enable relative movement of the first coupling half and second coupling half in opposite rotational directions to assume a second orientation where the first coupling half and the second coupling half are not in alignment, and are disconnected.

In 704, the method 700 may include moving the second coupling half in a rotational direction about the exemplary central axis A, relative to the first coupling half, from the first orientation to the second orientation. The exemplary contact edge discussed herein (e.g., the contact edge 644) is rotated clockwise from a point C to a point D shown in FIG. 6D when the second coupling half is rotated from the first orientation to the second orientation.

In 706, the method 700 may include opening the exemplary clasp coupled to the exemplary bottom portion discussed herein (e.g., the clasp 630 and the bottom portion 620) of the first coupling half, where the clasp moves away from the first coupling half. When the clasp is opened, the first coupling halves may be freely separated from each other, and thereby creating a disconnection between the tractor and trailer.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for disconnecting a hose from an autonomous vehicle, wherein the autonomous vehicle is selectively coupled to a trailer, the system comprising:
a coupler located along a hose, the coupler being selectively connected to the trailer; and
an actuation mechanism configured to impede movement of the coupler to maintain the coupler in a first orientation and to enable movement of the coupler to move to a second orientation.

2. The system for disconnecting a hose from an autonomous vehicle of claim 1 the coupler further comprising a pair of coupling halves, a second coupling half being movable relative to a first coupling half between the first orientation where a face of the first coupling half and a face of the second coupling half are held in sealing engagement and the second orientation where the first coupling half and the second coupling half are separated.

3. The system for disconnecting a hose from an autonomous vehicle of claim 2 wherein the face of the first coupling half and the face of the second coupling half each have an opening formed therethrough.

4. The system for disconnect a hose from an autonomous vehicle of claims 3 wherein the opening of the first coupling half is in fluid communication with the hose.

5. The system for disconnecting a hose from an autonomous vehicle of claim 1 the actuation mechanism having a body coupled to a top portion of the first coupling half and at least one mating connector configured to translate along the body via a pair of rails,
wherein the pair of rails enable movement of the at least one mating connector along the body.

6. The system for disconnecting a hose from an autonomous vehicle of claim 5 wherein the actuation mechanism further comprises a first mating connector and a second mating connector.

7. The system for disconnecting a hose from an autonomous vehicle of claim 1 wherein the actuation mechanism is configured to maintain relative positions of the first coupling half and the second coupling half substantially constant, and wherein the actuation mechanism is configured to enable a relative, opposed rotational motion between the first coupling half and the second coupling half.

8. The system for disconnecting a hose from an autonomous vehicle of claim 2 further comprising a clasp rotatably coupled to a bottom portion of the first coupling half, defining a channel therebetween.

9. The system for disconnecting a hose from an autonomous vehicle of claim 8 wherein a bottom portion of the second coupling half is located in the channel in the first orientation.

10. The system for disconnecting a hose from an autonomous vehicle of claim 8 wherein the clasp is adapted to rotate away from the first coupling half and enable the second coupling half to disconnect from the first coupling half.

11. A disconnecting device comprising:
a connecting member located along a supply line; and
an actuation mechanism configured to impede movement of the connecting member to maintain the connecting member in a first orientation and to enable movement of the connecting member to a second orientation.

12. The disconnecting device of claim 11 wherein the connecting member is a coupler and the supply line is a hose.

13. The disconnecting device of claim 11 the connecting member further comprising a pair of coupling halves, a second coupling half being movable relative to a first coupling half between the first orientation where a face of the first coupling half and a face of the second coupling half are held in sealing engagement and the second orientation where the first coupling half and the second coupling half are separated, the face of the first coupling half and the face of the second coupling half further comprising an opening formed therethrough, and the first coupling half further comprising a clasp rotatably coupled to a bottom portion of the first coupling half.

14. The disconnecting device of claim 13 wherein the opening of the first coupling half and/or the opening of the second coupling half are in communication with the supply line.

15. The disconnecting device of claim 13 the actuation mechanism having a body coupled to a top portion of the first coupling half and further comprising at least one mating connector configured to translate along the body via a pair of rails,
wherein the pair of rails enable movement of the at least one mating connector along the body.

16. The disconnecting device of claim 13 wherein the actuation mechanism is configured to maintain relative positions of the first coupling half and the second coupling half substantially constant, and wherein the actuation mechanism is configured to enable a relative, opposed motion between the sleeve and first coupling half and the second coupling half.

17. The disconnecting device of claim 11 wherein the actuation mechanism is electrically triggered or mechanically triggered.

18. A method of disconnecting a connecting system from an autonomous vehicle, wherein the autonomous vehicle is selectively coupled to a trailer, where the connecting system comprises a coupler having a first coupling half and a second coupling half, the first coupling half and the second coupling half being movable relative to each other, an actuation mechanism having a body and at least one mating connector moveably coupled to the body, the actuation mechanism coupled to a top portion of the first coupling half and configured to impede relative movement between the first and the second coupling halves in a first orientation where the first coupling half is connected to the trailer, and to enable relative movement of the first and the second coupling halves in opposite rotational directions to assume a second orientation where the first coupling half is disconnected from the trailer, and a clasp rotatably coupled to a bottom portion of the first coupling half, defining a channel therebetween, the method comprising:
holding a bottom portion of the second coupling half in the channel, wherein a sealing contact between the first coupling half and the second coupling half is maintained, allowing air flow through aligned central openings of the first and the second coupling halves;
impeding the relative movement between the first and the second coupling halves by the actuation mechanism to maintain a first orientation;
enabling the relative movement between the first and the second coupling halves by the actuation mechanism; and
rotating the first and the second coupling halves in opposite relative rotational directions to a second orientation and thereby disconnect the first coupling half from the trailer.

19. The method of claim 18, further comprising:
sending a signal to the actuation mechanism, the signal including disconnection instructions;
activating the actuation mechanism; and
rotating the second coupling half a predetermined distance relative to the first coupling half from the first orientation to the second orientation.

20. The method of claim 19, further comprising rotating the clasp away from a face of the first coupling half; and
releasing the first coupling half from the second coupling half.
